(19) United States
(12) Patent Application Publication
(10) Pub. No.: US 2026/0038247 A1
(43) Pub. Date: Feb. 5, 2026

(54) IMPLEMENTING OVERFITTING REDUCTION IN A PERSONALIZED MACHINE LEARNING MODEL

(71) Applicant: Lemon Inc., Grand Cayman (KY)

(72) Inventors: Tiancheng Zhi, Los Angeles, CA (US); Shen Sang, Los Angeles, CA (US); Jing Liu, Los Angeles, CA (US); Linjie Luo, Los Angeles, CA (US)

(21) Appl. No.: 18/792,525

(22) Filed: Aug. 1, 2024

(51) Int. Cl. G06V 10/774; G06N 20/00

(52) U.S. Cl. CPC G06V 10/774; G06N 20/00

(57) ABSTRACT

The present disclosure describes techniques for implementing overfitting reduction in a personalized machine learning model. At least one conditioning image is generated based on an image. The image comprises identity information of a user and structural information. At least one conditioning signal is generated based on the at least one conditioning image by at least one frozen conditioning model. The at least one conditioning signal indicates the structural information of the input image without the identity information. The personalized machine learning model corresponding to the user is fine-tuned based on the at least one conditioning signal. The personalized machine learning model is fine-tuned to disentangle the structural information from the identity information.

### BACKGROUND

Machine learning models are increasingly being used across a variety of industries to perform a variety of different tasks. Such tasks may include audio or vision related tasks. Improved techniques for generating high-quality images or videos are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing overfitting reduction in a personalized machine learning model in accordance with the present disclosure.

FIG. 2 shows example conditioning images in accordance with the present disclosure.

FIG. 3 shows example conditioning images in accordance with the present disclosure.

FIG. 4 shows an example system for implementing overfitting reduction in a personalized machine learning model in accordance with the present disclosure.

FIG. 5 shows an example system for implementing overfitting reduction in a personalized machine learning model in accordance with the present disclosure.

FIG. 6 shows an example process for implementing overfitting reduction in a personalized machine learning model in accordance with the present disclosure.

FIG. 7 shows an example process for implementing overfitting reduction in a personalized machine learning model in accordance with the present disclosure.

FIG. 8 shows an example process for generating conditioning signals in accordance with the present disclosure.

FIG. 9 shows an example process for generating conditioning signals in accordance with the present disclosure.

FIG. 10 shows an example process for generating conditioning signals in accordance with the present disclosure.

FIG. 11 shows an example process for implementing overfitting reduction in a personalized machine learning model in accordance with the present disclosure.

FIG. 12 shows an example process for implementing overfitting reduction in a personalized machine learning model in accordance with the present disclosure.

FIG. 13 shows an example computing device which may be used to perform any of the techniques disclosed herein.

### DETAILED DESCRIPTION OF ILLUSTRATIVE EMBODIMENTS

For some personalization applications, a single base machine learning model, such as a diffusion model, can be personalized, or fine-tuned, for a large number of different users. However, existing fine-tuned machine learning models often suffer from an overfitting problem. Overfitting occurs when the fine-tuned machine learning model is unable to generalize and fits too closely to the training dataset. Such an overfitting problem is likely to occur if the number of input images in the training dataset is small and/or if a large number of the scenes in the input images in the training dataset are similar to each other (e.g., feature the same type of pose, the same clothing, the same facial expressions, etc.). An overfitted fine-tuned machine learning model will generate images that inherit the same properties (e.g., pose, clothing, facial expression, etc.) as the properties featured in the input images of the training dataset. As such, techniques for implementing overfitting reduction in a personalized machine learning model is needed.

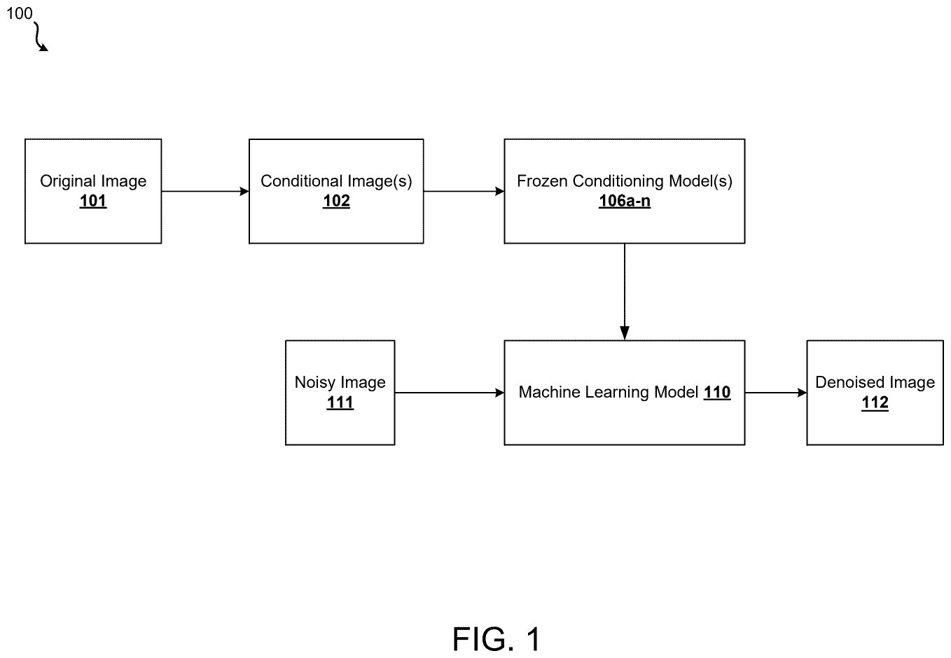

Described herein are techniques for implementing overfitting reduction in a personalized machine learning model. FIG. 1 shows an example system 100 for implementing overfitting reduction in a personalized machine learning model in accordance with the present disclosure. The system 100 includes a machine learning model 110. The machine learning model 110 may comprise a personalized machine learning model.

The personalized machine learning model can be generated by fine-tuning a base machine learning model. The base machine learning model can include any machine learning model, including but not limited to a large vision foundation model. The large vision foundation model can be pre-trained to generate images, such as new images from scratch. The large vision foundation model can include a stable diffusion model, a stable diffusion XL model, any/or any other large vision foundation model. The base machine learning model can be fine-tuned to generate a plurality of personalized machine learning models. Each of the plurality of fine-tuned machine learning models can correspond to a particular user from a plurality of users. For example, the machine learning model 110 can be fine-tuned for a particular user from a plurality of users.

The personalized machine learning model can be generated by finetuning the base machine learning model based on original image(s). The original image(s) can include at least one image received from (e.g., input by) the corresponding user. The original image(s) can include an image of the corresponding user, such as an image of a face of the corresponding user. The original image(s) can comprise or depict the identity information of the corresponding user, such as facial information and/or features that can be used to identify the corresponding user. The original image(s) can comprise or depict structural information. The structural information can include one or more of pose information, clothing information, spatial and/or depth information, outline information indicating the outlines of objects in the original image 101, and/or any other type of structural information.

In embodiments, one or more frozen conditioning models 106a-n can be configured to prevent overfitting of the machine learning model 110. To prevent overfitting of the machine learning model, at least one conditioning image 102 can be generated based on an original image 101. The at least one conditioning image 102 can depict at least a portion of the structural information associated with the original image 101. For example, the at least one conditioning image 102 can include a depth map (e.g., depth conditioning image), an edge detection image (e.g., canny conditioning image), a pose map (e.g., pose conditioning image), and/or any other type of conditioning image.

The least one conditioning image 102 can be input into (e.g., fed into) the frozen conditioning model(s) 106a-n. The frozen conditioning model(s) 106a-n can include one or more structural conditioning models. The structural conditioning model(s) can include a ControlNet model. A ControlNet model is a type of model for controlling image diffusion models by conditioning the model with an additional input image. A ControlNet model has two sets of weights (or blocks) connected by a zero-convolution layer: a locked copy keeps everything a large pretrained diffusion model has learned, and a trainable copy is trained on the additional conditioning input. Since the locked copy preserves the pretrained model, training and implementing a ControlNet on a new conditioning input is as fast as finetuning any other model because the model is not being trained from scratch. The structural conditioning model(s) can include a T2I Adapter model with depth condition. A T2I-Adapter is a lightweight adapter for controlling and providing more accurate structure guidance for text-to-image models. A T2I-Adapter works by learning an alignment between the internal knowledge of the text-to-image model and an external control signal, such as edge detection or depth estimation. A condition can be passed to four feature extraction blocks and three down-sample blocks. This makes it fast and easy to train different adapters for different conditions which can be plugged into the text-to-image model.

The frozen conditioning model(s) 106a-n can effectively absorb structural information from the original image 101 so that the structural information associated with the original image 101 is disentangled with the identity information associated with the original image 101. The frozen conditioning model(s) 106a-n can generate at least one conditioning signal. The frozen conditioning model(s) 106a-n can generate the at least one conditioning signal based on the at least one conditioning image 102. The at least one conditioning signal can be indicative of the structural information associated with the original image 101, but not the identity information associated with the original image 101.

In embodiments, the at least one conditioning image 102 can be processed prior to being input into the frozen conditioning model(s) 106a-n. The at least one conditioning image 102 can be processed to blur (e.g., obfuscate) or remove the identity information. The identity information can include facial information of identifying the user. Processing the at least one conditioning image 102 to blur (e.g., obfuscate) or remove the identity information can improve the ability of a personalized machine learning model to disentangle the structural information from the identity information of the corresponding user. For example, the at least one processed conditional image can blur, remove, or otherwise hide the identity information so that the identity of the user is imperceptible. The at least one processed conditional image can be input into (e.g., fed into) the frozen conditioning model(s) 106a-n.

The frozen conditioning model(s) 106a-n can effectively absorb structural information from the original image 101 so that the structural information associated with the original image 101 is disentangled with the identity information associated with the original image 101. The frozen conditioning model(s) 106a-n can generate the at least one conditioning signal based on the at least one processed conditional image. The at least one conditioning signal can be indicative of the structural information associated with the original image 101, but not the identity information associated with the original image 101.

The at least one conditioning signal can be input into (e.g., fed into) the machine learning model 110. The machine learning model 110 can be fine-tuned based on the at least one conditioning signal. Fine-tuning the machine learning model 110 can include training the machine learning model 110 to disentangle structural information contained in the original image from identity information of a user comprised in the original image. The machine learning model 110 can generate a de-noised image 112 by de-noising a noisy image 111 based on the at least one conditioning signal. The noisy image 111 can include a noised version of the original image 101. The de-noised image 112 can be identical to the original image 101.

Fine-tuning the machine learning model 110 based on the at least one conditioning signal can enable the personalized machine learning model to learn only the identify information associated with the original image 101 (e.g., not the structural information associated with the original image 101). The machine learning model 110 can be fine-tuned to disentangle the structural information from the identity information of the corresponding user. By enabling the machine learning model 110 to disentangle the structural information from the identity information, overfitting of the personalized machine learning model can be prevented. The fine-tuned personalized machine learning model can be used to generate a new image. The fine-tuned personalized machine learning model can generate the new image based on an input image depicting the corresponding user. The new image can include desired structural features (e.g., the structural features indicated by a text prompt).

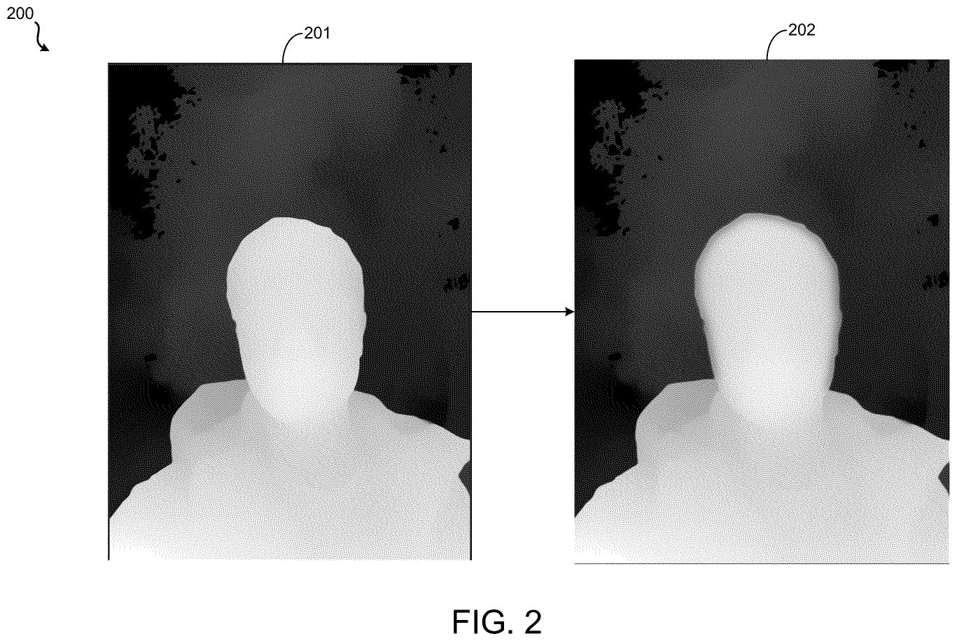

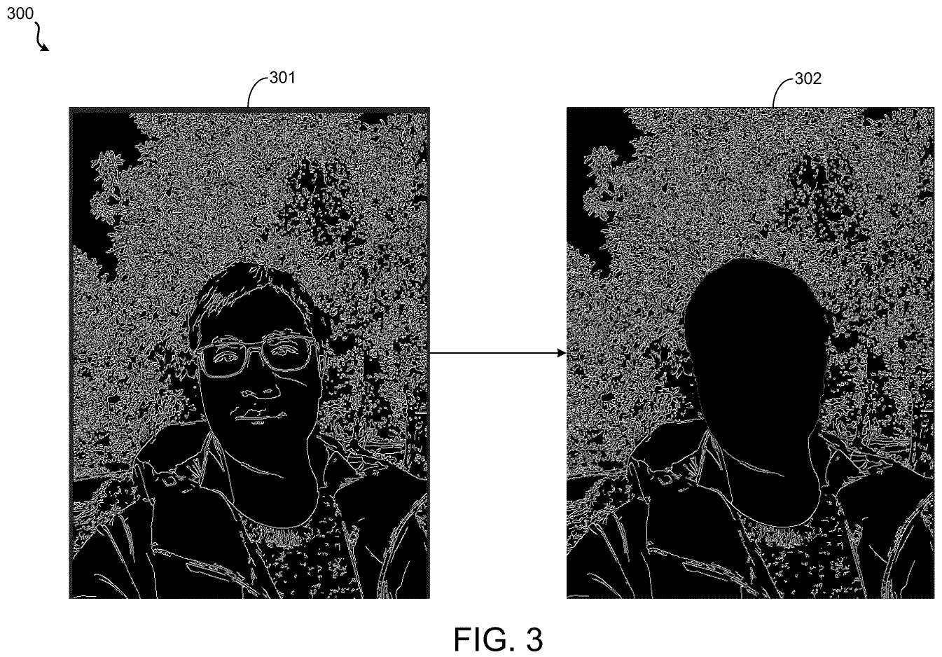

FIGS. 2-3 show example conditioning images. FIG. 2 shows a set 200 of conditioning images. The set 200 of conditioning images includes a conditioning image 201. The conditioning image 201 can be a depth map, for example. The depth map can include an image or image channel that contains information relating to the distance of the surfaces of objects in the original image 101 from a viewpoint. For example, the depth map can include spatial information. The depth map can indicate depth estimations of pixels in the original image 101. The conditioning image 201 can be processed to generate a processed conditioning image 202. The processed conditioning image 202 can include blurred (e.g., obfuscated) identity information. For example, if the conditioning image 201 depicts any identity information associated with a particular user corresponding to a personalized machine learning model, the processed conditioning image 202 can blur (e.g., obfuscate) at least a portion of the identity information depicted in the conditioning image 201.

FIG. 3 shows a set 300 of conditioning images. The set 300 of conditioning images includes a conditioning image 301. The conditioning image 301 can be a canny conditioning image, for example. The canny conditioning image can include an image that contains information relating to the edges or outlines of objects in the original image 101. The conditioning image 301 can be processed to generate a processed conditioning image 302. The processed conditioning image 302 can include blurred (e.g., obfuscated) identity information. For example, if the conditioning image 301 depicts any identity information associated with the corresponding user, the processed conditioning image 302 can blur (e.g., obfuscate) at least a portion of the identity information depicted in the conditioning image 301.

In embodiments, the personalized machine learning model can be simultaneously fine-tuned using a plurality of conditioning signals. Each of the plurality of conditioning signals can indicate different structural information of the image without the identity information.

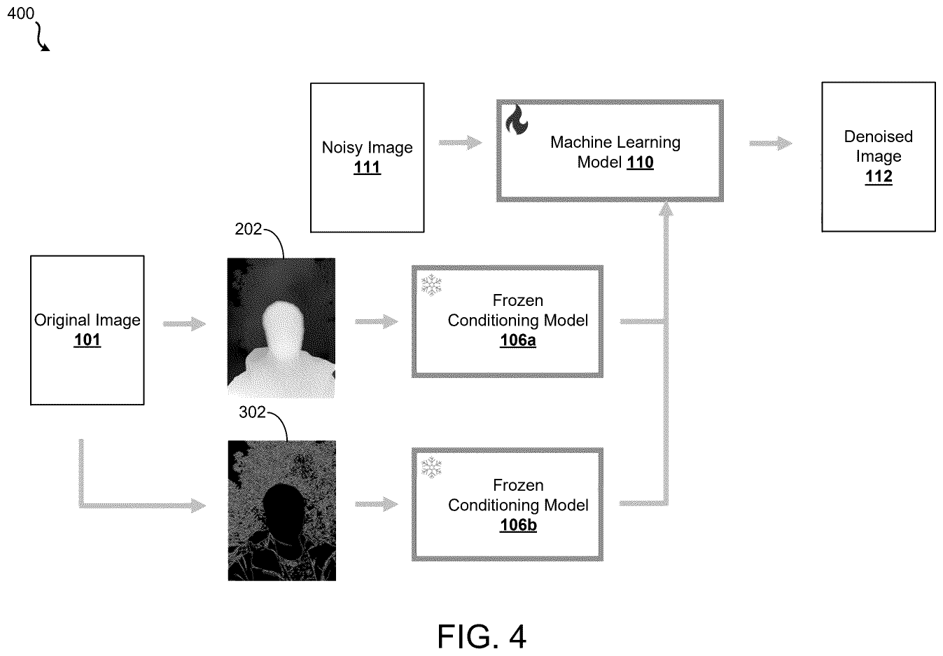

FIG. 4 shows an example system 400 for fine-tuning a personalized machine learning model using a plurality of conditioning signals. A plurality of conditioning images, such as the processed conditioning image 202 and the processed conditioning image 302, can be generated based on the original image 101. The plurality of conditioning images can depict at least a portion of the structural information associated with the original image 101. For example, the processed conditioning image 202 can include a processed depth map (e.g., depth conditioning image) and the processed conditioning image 302 can include an edge detection image (e.g., canny conditioning image).

The plurality of conditioning images can be input into (e.g., fed into) a plurality of frozen conditioning models. Each of the plurality of conditioning images can be input into a separate frozen conditioning models from the plurality of frozen conditioning models. For example, the processed conditioning image 202 can be input into a first frozen conditioning model 106a from the plurality of frozen conditioning models and the processed conditioning image 302 can be input into a second frozen conditioning model 106b from the plurality of frozen conditioning models. Each of the plurality of conditioning images can simultaneously input into the corresponding frozen conditioning model. For example, the processed conditioning image 202 and the processed conditioning image 302 can be simultaneously input into the first frozen conditioning model 106a and the second frozen conditioning model 106b, respectively. The frozen conditioning models 106a-b can effectively absorb structural information from the original image 101 so that the structural information associated with the original image 101 is disentangled with the identity information associated with the original image 101.

The frozen conditioning model 106a can generate at least one first conditioning signal based on the processed conditioning image 202. The at least one first conditioning signal can be indicative of the structural information associated with the original image 101, but not the identity information associated with the original image 101. For example, at least one first conditioning signal can be indicative of depth information associated with the original image 101, but not the identity information associated with the original image 101. The frozen conditioning model 106b can generate at least one second conditioning signal based on the processed conditioning image 302. The at least one second conditioning signal can be indicative of the structural information associated with the original image 101, but not the identity information associated with the original image 101. For example, the at least one second conditioning signal can be indicative of edge or outline information associated with the original image 101, but not the identity information associated with the original image 101.

The at least one first conditioning signal and the at least one second conditioning signal can be input into (e.g., fed into) the machine learning model 110 to fine-tune the machine learning model 110. The at least one first conditioning signal and the at least one second conditioning signal can be simultaneously input into (e.g., fed into) the machine learning model 110 to fine-tune the machine learning model 110. The machine learning model 110 can be fine-tuned based on the at least one first conditioning signal and the at least one second conditioning signal. The machine learning model 110 can generate a denoised image 101 by de-noising a noisy image 111 based on the at least one first conditioning signal and the at least one second conditioning signal. The noisy image 111 can include a noised version of the original image 101.

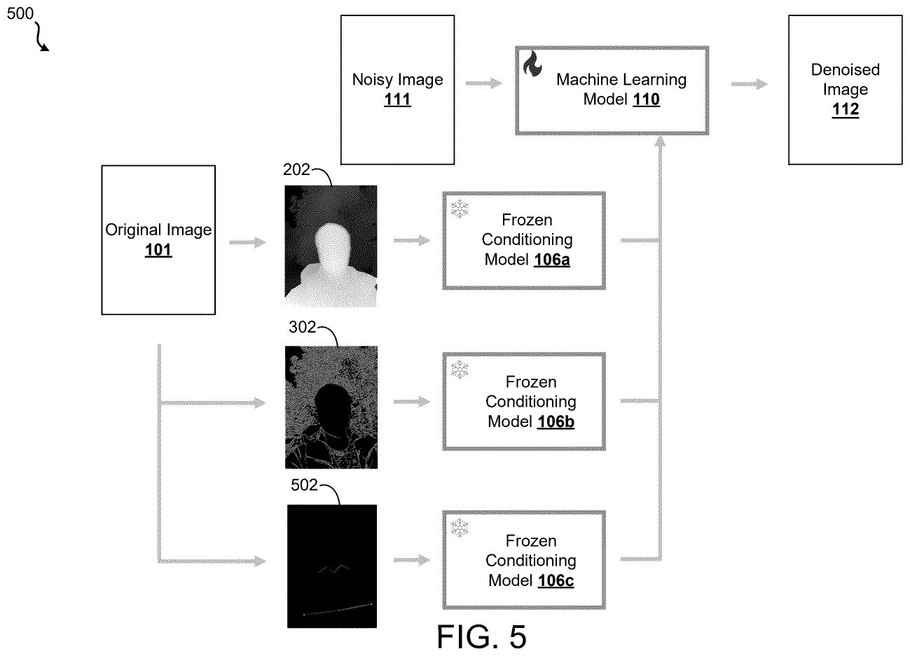

FIG. 5 shows another example system 500 for fine-tuning a personalized machine learning model using a plurality of conditioning signals. A plurality of conditioning images, such as the processed conditioning image 202, the processed conditioning image 302, and a conditioning image 502, can be generated based on the original image 101. The plurality of conditioning images can depict at least a portion of the structural information associated with the original image 101. For example, the processed conditioning image 202 can include a processed depth map (e.g., depth conditioning image), the processed conditioning image 302 can include an edge detection image (e.g., canny conditioning image), and the conditioning image 502 can include an image indicating pose information associated with the original image 101.

The plurality of conditioning images can be input into (e.g., fed into) a plurality of frozen conditioning models. Each of the plurality of conditioning images can be input into a separate frozen conditioning models from the plurality of frozen conditioning models. For example, the processed conditioning image 202 can be input into a first frozen conditioning model 106a from the plurality of frozen conditioning models, the processed conditioning image 302 can be input into a second frozen conditioning model 106b from the plurality of frozen conditioning models, and the conditioning image 502 can be input into a third frozen conditioning model 106c from the plurality of frozen conditioning models.

Each of the plurality of conditioning images can simultaneously input into the corresponding frozen conditioning model. For example, the processed conditioning image 202, the processed conditioning image 302, and the conditioning image 502 can be simultaneously input into the first frozen conditioning model 106a, the second frozen conditioning model 106b, and the third frozen conditioning model 106c, respectively, The frozen conditioning models 106a-c can effectively absorb structural information from the original image 101 so that the structural information associated with the original image 101 is disentangled with the identity information associated with the original image 101.

The frozen conditioning model 106a can generate at least one first conditioning signal based on the processed conditioning image 202. The at least one first conditioning signal can be indicative of the structural information associated with the original image 101, but not the identity information associated with the original image 101. For example, at least one first conditioning signal can be indicative of depth information associated with the original image 101, but not the identity information associated with the original image 101. The frozen conditioning model 106b can generate at least one second conditioning signal based on the processed conditioning image 302. The at least one second conditioning signal can be indicative of the structural information associated with the original image 101, but not the identity information associated with the original image 101. For example, at least one second conditioning signal can be indicative of edge or outline information associated with the original image 101, but not the identity information associated with the original image 101. The frozen conditioning model 106c can generate at least one third conditioning signal based on the conditioning image 502. The at least one third conditioning signal can be indicative of the structural information associated with the original image 101, but not the identity information associated with the original image 101. For example, the at least one third conditioning signal can be indicative of pose information associated with the original image 101, but not the identity information associated with the original image 101.

The at least one first conditioning signal, the at least one second conditioning signal, and the at least one third conditioning signal can be input into (e.g., fed into) the machine learning model 110 to fine-tune the machine learning model 110. The at least one first conditioning signal, the at least one second conditioning signal, and the at least one third conditioning signal can be simultaneously input into (e.g., fed into) the machine learning model 110 to fine-tune the machine learning model 110. The machine learning model 110 can be fine-tuned based on the at least one first conditioning signal, the at least one second conditioning signal, and the at least one third conditioning signal. The machine learning model 110 can generate a de-noised image 112 by de-noising a noisy image 111 based on the at least one first conditioning signal, the at least one second conditioning signal, and the at least one third conditioning signal. The noisy image 111 can include a noised version of the original image 101 The de-noised image 101 can be identical to the original image 101.

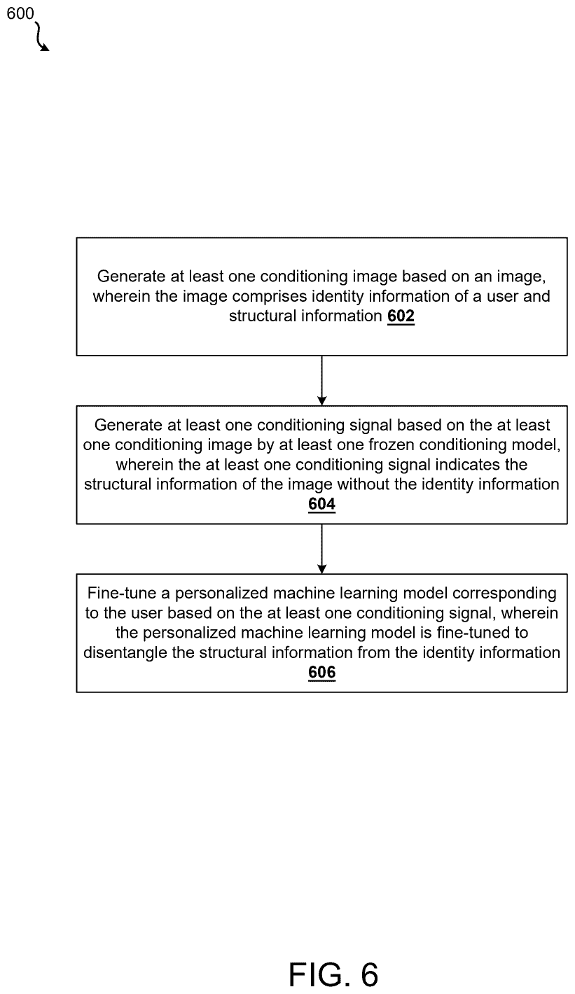

FIG. 6 illustrates an example process 600 for implementing overfitting reduction in a personalized machine learning model. Although depicted as a sequence of operations in FIG. 6, those of ordinary skill in the art will appreciate that various embodiments may add, remove, reorder, or modify the depicted operations.

One or more frozen conditioning models can be used to prevent overfitting of a personalized machine learning model. To prevent overfitting of the personalized machine learning model, at least one conditioning image can be generated. At 602, at least one conditioning image can be generated based on an image. The image can include structural information. For example, the at least one conditioning image can depict at least a portion of the structural information.

associated with the image. For example, the at least one conditioning image can include a depth map (e.g., depth conditioning image), an edge detection image (e.g., canny conditioning image), a pose map (e.g., pose conditioning image), and/or any other type of conditioning image.

The least one conditioning image can be input into (e.g., fed into) at least one frozen conditioning model. The frozen conditioning model(s) can include one or more structural conditioning models. The structural conditioning model(s) can include a ControlNet model or a T2I Adapter model with depth condition. At 604, at least one conditioning signal can be generated. The at least one conditioning signal can be generated based on the at least one conditioning image. The at least one conditioning signal can be generated by the at least one frozen conditioning model. The at least one conditioning signal indicates the structural information of the input image without the identity information. The frozen conditioning model(s) can effectively absorb structural information from the image so that the structural information associated with the image is disentangled with the identity information associated with the image.

At 606, the personalized machine learning model can be fine-tuned. The personalized machine learning model can be fine-tuned based on the at least one conditioning signal. The personalized machine learning model can be fine-tuned to disentangle the structural information from the identity information. Fine-tuning the personalized machine learning model can include training the personalized machine learning model to de-noise a noisy image based on the at least one conditioning signal to generate a de-noised image. The noisy image can include a noised version of the input image. For example, the noisy image can be generated based on adding noise to the original image. The de-noised image can be identical to the original image.

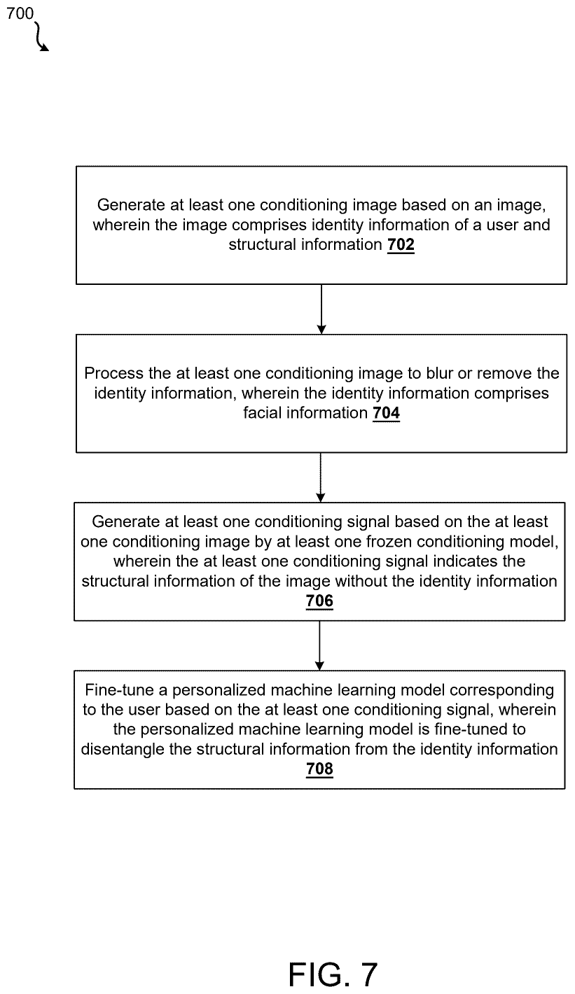

FIG. 7 illustrates an example process 700 for implementing overfitting reduction in a personalized machine learning model. Although depicted as a sequence of operations in FIG. 7, those of ordinary skill in the art will appreciate that various embodiments may add, remove, reorder, or modify the depicted operations.

One or more frozen conditioning models can be used to prevent overfitting of a personalized machine learning model. To prevent overfitting of the personalized machine learning model, at least one conditioning image can be generated. At 702, at least one conditioning image can be generated based on an image. The image can include structural information. For example, the at least one conditioning image can depict at least a portion of the structural information associated with the image. For example, the at least one conditioning image can include a depth map (e.g., depth conditioning image), an edge detection image (e.g., canny conditioning image), a pose map (e.g., pose conditioning image), and/or any other type of conditioning image.

At 704, the at least one conditioning image can be processed. The at least one conditioning image can be processed to blur (e.g., obfuscate) or remove the identity information. The identity information can include facial information of identifying the user. Processing the at least one conditioning image to blur (e.g., obfuscate) or remove the identity information can improve the ability of the fine-tuned personalized machine learning model to disentangle the structural information from the identity information of the corresponding user.

The least one processed conditioning image can be input into (e.g., fed into) at least one frozen conditioning model. The frozen conditioning model(s) can include one or more structural conditioning models. The structural conditioning model(s) can include a ControlNet model or a T2I Adapter model with depth condition. At 706, at least one conditioning signal can be generated. The at least one conditioning signal can be generated based on the at least one conditioning image. The at least one conditioning signal can be generated by the at least one frozen conditioning model. The at least one conditioning signal indicates the structural information of the input image without the identity information. The frozen conditioning model(s) can effectively absorb structural information from the image so that the structural information associated with the image is disentangled with the identity information associated with the image.

At 708, the personalized machine learning model can be fine-tuned. The personalized machine learning model can be fine-tuned based on the at least one conditioning signal. The personalized machine learning model can be fine-tuned to disentangle the structural information from the identity information of a user. Fine-tuning the personalized machine learning model can include training the personalized machine learning model to generate a de-noised image by de-noising a noisy image based on the at least one conditioning signal. The noisy image can include a noised version of the input image. For example, the noisy image can be generated based on adding noise to the original image. The de-noised image can be identical to the original image.

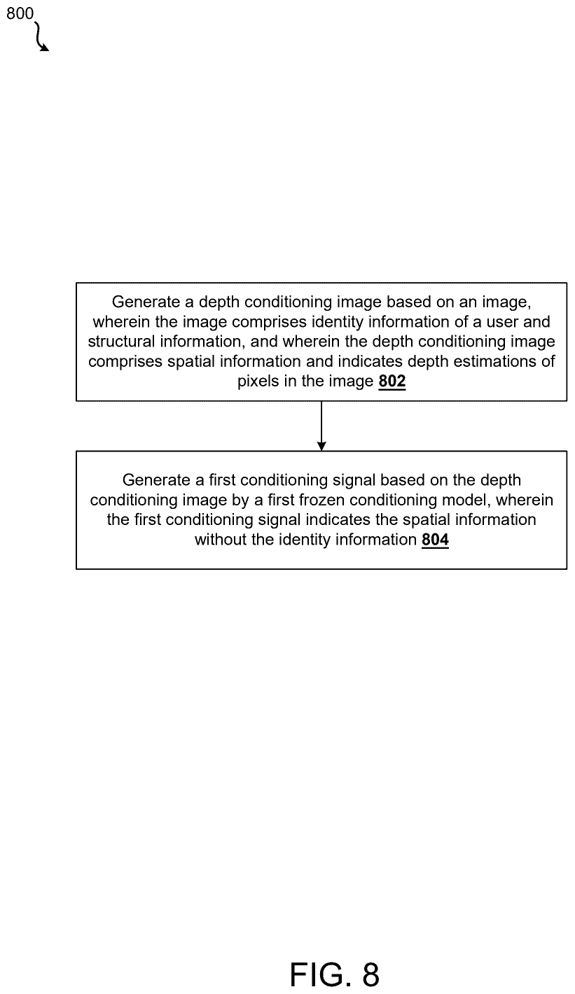

FIG. 8 illustrates an example process 800 for generating a conditioning signal. Although depicted as a sequence of operations in FIG. 8, those of ordinary skill in the art will appreciate that various embodiments may add, remove, reorder, or modify the depicted operations.

One or more frozen conditioning models can be used to prevent overfitting of a personalized machine learning model. To prevent overfitting of the personalized machine learning model, at least one conditioning image can be generated. At 802, a depth conditioning image can be generated based on an image. The image can include structural information. The depth conditioning image can depict at least a portion of the structural information associated with the image. The depth conditioning image can comprise spatial information. The depth conditioning image can indicate depth estimations of pixels in the image.

The depth conditioning image can be input into (e.g., fed into) a first frozen conditioning model. The first frozen conditioning model can include a structural conditioning model. The structural conditioning model can include a ControlNet model or a T2I Adapter model with depth condition. At 804, a first conditioning signal can be generated. The first conditioning signal can be generated based on the depth conditioning image. The first conditioning signal can be generated by the first frozen conditioning model. The first conditioning signal indicates the spatial information of the input image without the identity information. The first frozen conditioning model can effectively absorb the spatial information from the image so that the spatial information associated with the image is disentangled with the identity information associated with the image.

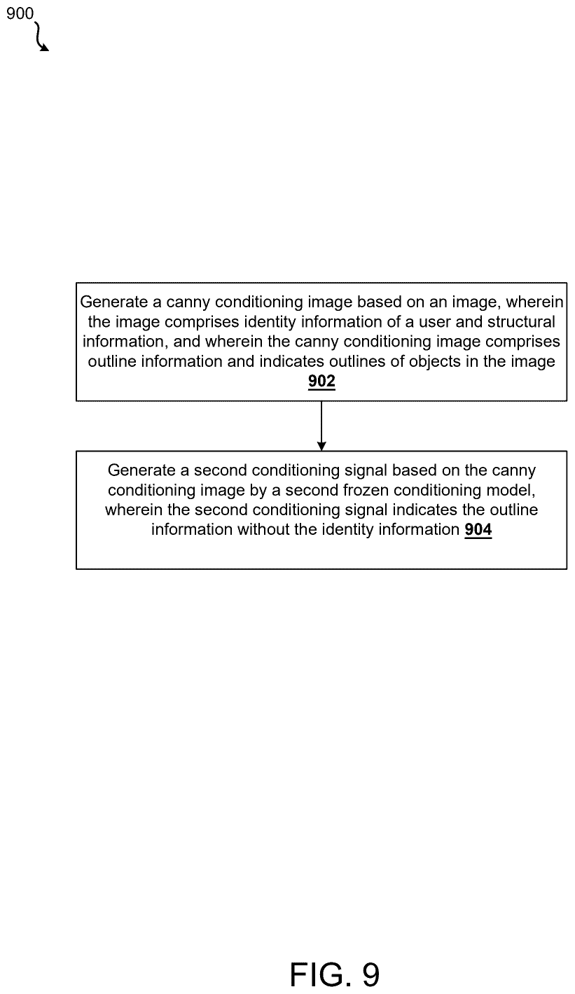

FIG. 9 illustrates an example process 900 for generating a conditioning signal. Although depicted as a sequence of operations in FIG. 9, those of ordinary skill in the art will appreciate that various embodiments may add, remove, reorder, or modify the depicted operations.

One or more frozen conditioning models can be used to prevent overfitting of a personalized machine learning model. To prevent overfitting of the personalized machine learning model, at least one conditioning image can be generated. At 902, a canny conditioning image can be generated based on an image. The image can include structural information. The canny conditioning image can depict at least a portion of the structural information associated with the image. The canny conditioning image can comprise outline information. The canny conditioning image can indicate outlines of objects in the image.

The canny conditioning image can be input into (e.g., fed into) a second frozen conditioning model. The second frozen conditioning model can include a structural conditioning model. At 904, a second conditioning signal can be generated. The second conditioning signal can be generated based on the canny conditioning image. The second conditioning signal can be generated by the second frozen conditioning model. The second conditioning signal indicates the outline information of the input image without the identity information. The second frozen conditioning model can effectively absorb the outline information from the image so that the outline information associated with the image is disentangled with the identity information associated with the image.

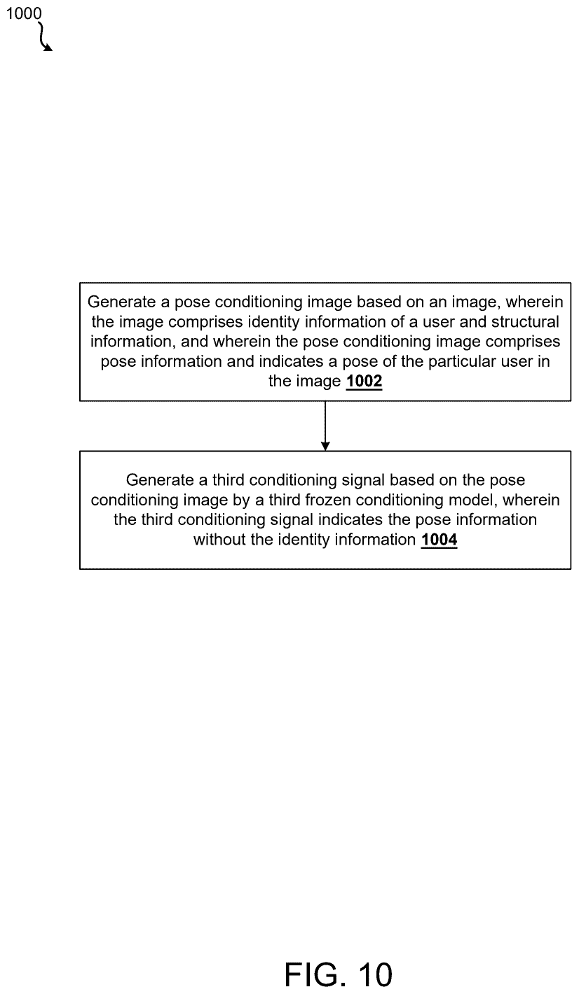

FIG. 10 illustrates an example process 1000 for generating a conditioning signal. Although depicted as a sequence of operations in FIG. 10, those of ordinary skill in the art will appreciate that various embodiments may add, remove, reorder, or modify the depicted operations.

One or more frozen conditioning models can be used to prevent overfitting of a personalized machine learning model. To prevent overfitting of the personalized machine learning model, at least one conditioning image can be generated. At 1002, a pose conditioning image can be generated based on an image. The image can include identity information of user. The image can include structural information. The pose conditioning image can depict at least a portion of the structural information associated with the image. The pose conditioning image can comprise pose information. The pose conditioning image can indicate a pose of a user in the image.

The pose conditioning image can be input into (e.g., fed into) a third frozen conditioning model. The third frozen conditioning model can include a structural conditioning model. At 904, a third conditioning signal can be generated. The third conditioning signal can be generated based on the pose conditioning image. The third conditioning signal can be generated by the third frozen conditioning model. The third conditioning signal indicates the outline information of the input image without the identity information. The third frozen conditioning model can effectively absorb the pose information from the image so that the pose information is disentangled with the identity information associated with the image.

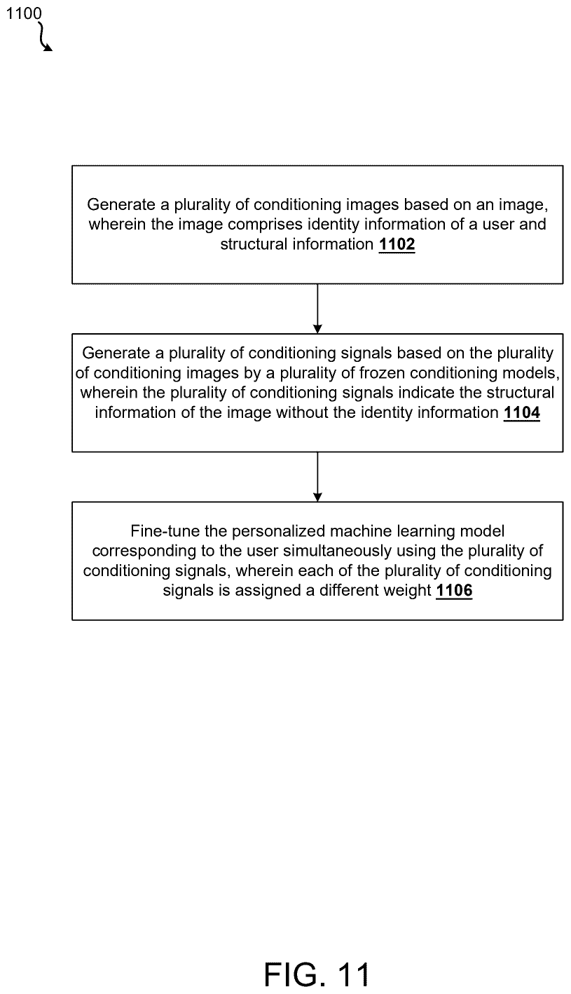

FIG. 11 illustrates an example process 1100 for implementing overfitting reduction in a personalized machine learning model. Although depicted as a sequence of operations in FIG. 11, those of ordinary skill in the art will appreciate that various embodiments may add, remove, reorder, or modify the depicted operations.

A plurality of frozen conditioning models can be used to prevent overfitting of a personalized machine learning model. To prevent overfitting of the personalized machine learning model, at a plurality of conditioning image scan be generated. At 1102, a plurality of conditioning images can be generated based on an image. The image can include identity information of a user. The image can include structural information. For example, the plurality of conditioning images can depict at least a portion of the structural information associated with the image. For example, the plurality of conditioning images can include a depth map (e.g., depth conditioning image), an edge detection image (e.g., canny conditioning image), a pose map (e.g., pose conditioning image), and/or any other type of conditioning image.

The plurality of conditioning images can be input into (e.g., fed into) a plurality of frozen conditioning models. The plurality of frozen conditioning models can include a plurality of structural conditioning models. Each of the structural conditioning models can include a ControlNet model or a T2I Adapter model with depth condition. At 1104, a plurality of conditioning signals can be generated. The plurality of conditioning signals can be generated based on the plurality of conditioning images. The plurality of conditioning signals can be generated by the plurality of frozen conditioning models. The plurality of conditioning signals indicates the structural information of the input image without the identity information of the user. The plurality of frozen conditioning models can effectively absorb structural information from the image so that the structural information associated with the image is disentangled with the identity information associated with the image.

At 1106, a personalized machine learning model can be fine-tuned. The personalized machine learning model can be fine-tuned based on the plurality of conditioning signals. The personalized machine learning model can be fine-tuned to disentangle the structural information from the identity information. Fine-tuning the personalized machine learning model can include training a machine learning model to generate a de-noised image by de-noising a noisy image based on the plurality of conditioning signals. The noisy image can include a noised version of the input image. For example, the noisy image can be generated based on adding noise to the original image. The de-noised image can be identical to the original image.

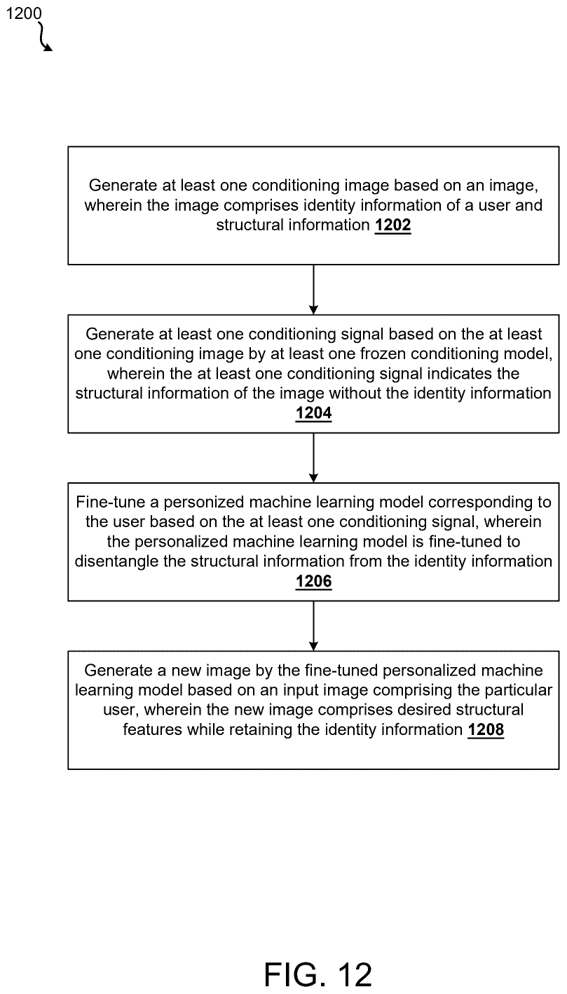

FIG. 12 illustrates an example process 1200 for implementing overfitting reduction in a personalized machine learning model. Although depicted as a sequence of operations in FIG. 12, those of ordinary skill in the art will appreciate that various embodiments may add, remove, reorder, or modify the depicted operations.

One or more frozen conditioning models can be used to prevent overfitting of a personalized machine learning model. To prevent overfitting of the personalized machine learning model, at least one conditioning image can be generated. At 1202, at least one conditioning image can be generated based on an image. The image can include structural information. For example, the at least one conditioning image can depict at least a portion of the structural information associated with the image. For example, the at least one conditioning image can include a depth map (e.g., depth conditioning image), an edge detection image (e.g., canny conditioning image), a pose map (e.g., pose conditioning image), and/or any other type of conditioning image.

The least one conditioning image can be input into (e.g., fed into) at least one frozen conditioning model. The frozen conditioning model(s) can include one or more structural conditioning models. The structural conditioning model(s) can include a ControlNet model or a T2I Adapter model with depth condition. At 1204, at least one conditioning signal can be generated. The at least one conditioning signal can be generated based on the at least one conditioning image. The at least one conditioning signal can be generated by the at least one frozen conditioning model. The at least one conditioning signal indicates the structural information of the input image without the identity information. The frozen conditioning model(s) can effectively absorb structural information from the image so that the structural information associated with the image is disentangled with the identity information associated with the image.

At 1206, the personalized machine learning model can be fine-tuned. The personalized machine learning model can be fine-tuned based on the at least one conditioning signal. The personalized machine learning model can be fine-tuned to disentangle the structural information from the identity information. Fine-tuning the personalized machine learning model can include training a machine learning model to generate a de-noised image. Training the machine learning model to generate the de-noised image can include training the machine learning model to de-noise a noisy image based on the at least one conditioning signal. The noisy image can include a noised version of the input image. For example, the noisy image can be generated based on adding noise to the original image. The de-noised image can be identical to the original image.

At 1208, a new image can be generated. The new image can be generated by the fine-tuned personalized machine learning model. The new image can be generated by the fine-tuned personalized machine learning model based on an input image comprising the user. The new image can include desired structural features (e.g., the structural features indicated by a text prompt).

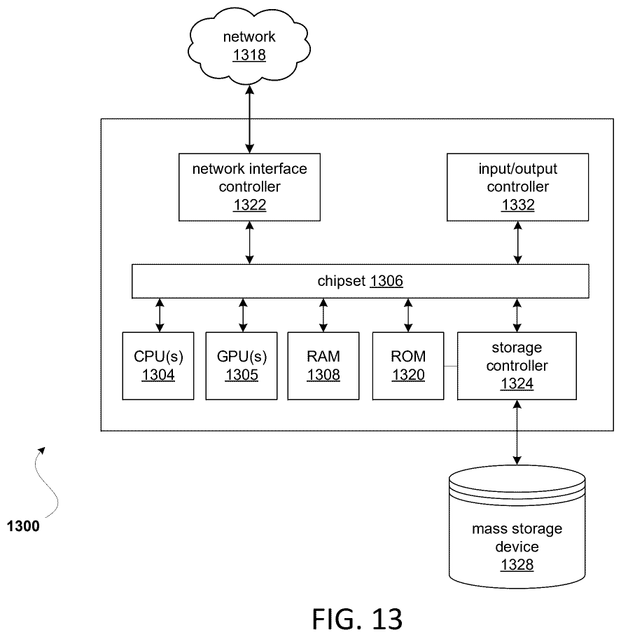

FIG. 13 illustrates a computing device that may be used in various aspects, such as the model(s), components, and/or devices depicted in FIGS. 1, 4, and 5. With regard to FIGS. 1, 4, and 5, any or all of the components may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component 1310. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing overfitting reduction in a personalized machine learning model, comprising:
generating at least one conditioning image based on an image, wherein the image comprises identity information of a user and structural information;
generating at least one conditioning signal based on the at least one conditioning image by at least one frozen conditioning model, wherein the at least one conditioning signal indicates the structural information of the image without the identity information; and
fine-tuning the personalized machine learning model corresponding to the user based on the at least one conditioning signal, wherein the personalized machine learning model is fine-tuned to disentangle the structural information from the identity information.

2. The method of claim 1, further comprising:
processing the at least one conditioning image to blur or remove the identity information, wherein the identity information comprises facial information.

3. The method of claim 1, further comprising:
generating a depth conditioning image based on the image, wherein the depth conditioning image comprises spatial information and indicates depth estimations of pixels in the image; and
generating a first conditioning signal based on the depth conditioning image by a first frozen conditioning model, wherein the first conditioning signal indicates the spatial information without the identity information.

4. The method of claim 1, further comprising:
generating a canny conditioning image based on the image, wherein the canny conditioning image comprises outline information and indicates outlines of objects in the image; and
generating a second conditioning signal based on the canny conditioning image by a second frozen conditioning model, wherein the second conditioning signal indicates the outline information without the identity information.

5. The method of claim 1, further comprising:
generating a pose conditioning image based on the image, wherein the pose conditioning image comprises pose information and indicates a pose of the user in the image; and
generating a third conditioning signal based on the pose conditioning image by a third frozen conditioning model, wherein the third conditioning signal indicates the pose information without the identity information.

6. The method of claim 1, further comprising:
fine-tuning the personalized machine learning model simultaneously using a plurality of conditioning signals, wherein the plurality of conditioning signals indicate the structural information of the image without the identity information; and
assigning different weights to the plurality of conditioning signals for fine-tuning the personalized machine learning model.

7. The method of claim 1, further comprising:
generating a new image by the fine-tuned personalized machine learning model based on an input image comprising the user, wherein the new image comprises desired structural features while retaining the identity information.

8. A system for implementing overfitting reduction in a personalized machine learning model, comprising:
at least one processor; and
at least one memory communicatively coupled to the at least one processor and comprising computer-readable instructions that upon execution by the at least one processor cause the at least one processor to perform operations comprising:
generating at least one conditioning image based on an image, wherein the image comprises identity information of a user and structural information;
generating at least one conditioning signal based on the at least one conditioning image by at least one frozen conditioning model, wherein the at least one conditioning signal indicates the structural information of the image without the identity information; and
fine-tuning the personalized machine learning model corresponding to the user based on the at least one conditioning signal, wherein the personalized machine learning model is fine-tuned to disentangle the structural information from the identity information.

9. The system of claim 8, the operations further comprising:
processing the at least one conditioning image to blur or remove the identity information, wherein the identity information comprises facial information.

10. The system of claim 8, the operations further comprising:
generating a depth conditioning image based on the image, wherein the depth conditioning image comprises spatial information and indicates depth estimations of pixels in the image; and
generating a first conditioning signal based on the depth conditioning image by a first frozen conditioning model, wherein the first conditioning signal indicates the spatial information without the identity information.

11. The system of claim 8, the operations further comprising:
generating a canny conditioning image based on the image, wherein the canny conditioning image comprises outline information and indicates outlines of objects in the image; and
generating a second conditioning signal based on the canny conditioning image by a second frozen conditioning model, wherein the second conditioning signal indicates the outline information without the identity information.

12. The system of claim 8, the operations further comprising:
generating a pose conditioning image based on the image, wherein the pose conditioning image comprises pose information and indicates a pose of the user in the image; and
generating a third conditioning signal based on the pose conditioning image by a third frozen conditioning model, wherein the third conditioning signal indicates the pose information without the identity information.

13. The system of claim 8, the operations further comprising:
fine-tuning the personalized machine learning model simultaneously using a plurality of conditioning signals, wherein the plurality of conditioning signals indicate the structural information of the image without the identity information; and
assigning different weights to the plurality of conditioning signals for fine-tuning the personalized machine learning model.

14. The system of claim 8, the operations further comprising:
generating a new image by the fine-tuned personalized machine learning model based on an input image comprising the user, wherein the new image comprises desired structural features while retaining the identity information.

15. A non-transitory computer-readable storage medium, storing computer-readable instructions that upon execution by a processor cause the processor to implement operations comprising:
generating at least one conditioning image based on an image, wherein the image comprises identity information of a user and structural information;
generating at least one conditioning signal based on the at least one conditioning image by at least one frozen conditioning model, wherein the at least one conditioning signal indicates the structural information of the image without the identity information; and
fine-tuning the personalized machine learning model corresponding to the user based on the at least one conditioning signal, wherein the personalized machine learning model is fine-tuned to disentangle the structural information from the identity information.

16. The non-transitory computer-readable storage medium of claim 15, the operations further comprising:
processing the at least one conditioning image to blur or remove the identity information, wherein the identity information comprises facial information.

17. The non-transitory computer-readable storage medium of claim 15, the operations further comprising:
generating a depth conditioning image based on the image, wherein the depth conditioning image comprises spatial information and indicates depth estimations of pixels in the image; and
generating a first conditioning signal based on the depth conditioning image by a first frozen conditioning model, wherein the first conditioning signal indicates the spatial information without the identity information.

18. The non-transitory computer-readable storage medium of claim 15, the operations further comprising:
generating a canny conditioning image based on the image, wherein the canny conditioning image comprises outline information and indicates outlines of objects in the image; and
generating a second conditioning signal based on the canny conditioning image by a second frozen conditioning model, wherein the second conditioning signal indicates the outline information without the identity information.

19. The non-transitory computer-readable storage medium of claim 15, the operations further comprising:
generating a pose conditioning image based on the image, wherein the pose conditioning image comprises pose information and indicates a pose of the user in the image; and
generating a third conditioning signal based on the pose conditioning image by a third frozen conditioning model, wherein the third conditioning signal indicates the pose information without the identity information.

20. The non-transitory computer-readable storage medium of claim 15, the operations further comprising:
fine-tuning the personalized machine learning model simultaneously using a plurality of conditioning signals, wherein the plurality of conditioning signals indicate the structural information of the image without the identity information; and
assigning different weights to the plurality of conditioning signals for fine-tuning the personalized machine learning model.
